(19) United States
(12) Patent Application Publication
(10) Pub. No.: US 2025/0058608 A1
(43) Pub. Date: Feb. 20, 2025

(54) RETRACTABLE WINDSHIELD SHADE

(71) Applicant: Kelby Hedrick, Greensburg, IN (US)

(72) Inventor: Kelby Hedrick, Greensburg, IN (US)

(21) Appl. No.: 18/233,756

(22) Filed: Aug. 14, 2023

(51) Int. Cl. B60J 3/02

(52) U.S. Cl. CPC B60J 3/02

(57) ABSTRACT

A retractable windshield shade removably connected to at least a portion of a vehicle, the retractable windshield shade including a main body to movably cover a windshield of the vehicle, a roller connector disposed on at least a portion of the main body and connected within a headliner of the vehicle to store the main body therein, such that the main body moves from retracted within the roller connector in a first position to at least partially extracted away from the roller connector in a second position, and moves from extracted away from the roller connector in the second position to retracted within the roller connector in the first position, and a surface connector disposed on at least a portion of the main body to removably connect the main body to a dashboard of the vehicle.

### BACKGROUND

### 1. Field

The present general inventive concept relates generally to a windshield shade, and particularly, to a retractable windshield shade.

### 2. Description of the Related Art

Many people that own a vehicle will have to park the vehicle at an outdoor location, which can it expose an interior of the vehicle to hot temperatures due to exposure to the Sun. Moreover, hot temperatures within the vehicle are not only harmful to people, but can cause damage to the vehicle including overheating equipment and/or cracking of material within the interior.

Windshield covers are commonly used to prevent the dash from overheating and/or cracking. However, windshield covers are a separatee accessory that must be purchased and deployed within the vehicle. While the windshield cover can protect the interior of the vehicle, it can be lost and/or misplaced prior to use

Therefore, there is a need for a retractable windshield shade that is already connected to the vehicle and can be extracted whenever it is needed.

### SUMMARY

The present general inventive concept provides a retractable windshield shade.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a retractable windshield shade removably connected to at least a portion of a vehicle, the retractable windshield shade including a main body to movably cover a windshield of the vehicle, a roller connector disposed on at least a portion of the main body and connected within a headliner of the vehicle to store the main body therein, such that the main body moves from retracted within the roller connector in a first position to at least partially extracted away from the roller connector in a second position, and moves from extracted away from the roller connector in the second position to retracted within the roller connector in the first position, and a surface connector disposed on at least a portion of the main body to removably connect the main body to a dashboard of the vehicle.

The main body may include an interior side to darken an interior of the vehicle while the interior side is extracted, and an exterior side disposed on at least a portion of the interior side to reduce an amount of light reaching the interior of the vehicle through the windshield.

The exterior side may be a reflective surface that reflects the light away therefrom.

The exterior side may absorb the light and prevents emission of the light away therefrom.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an elevational front view of a retractable windshield shade, according to an exemplary embodiment of the present general inventive concept;

FIG. 2 illustrates a front perspective view of the retractable windshield shade as disposed within an interior of a vehicle, according to an exemplary embodiment of the present general inventive concept; and

FIG. 3 illustrates a rear perspective view of the retractable windshield shade as disposed within the interior of the vehicle, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Retractable Windshield Shade 100
Main Body 110
Interior Side 111
Exterior Side 112
Mirror Receiving Channel 113
Roller Connector 120
Surface Connector 130

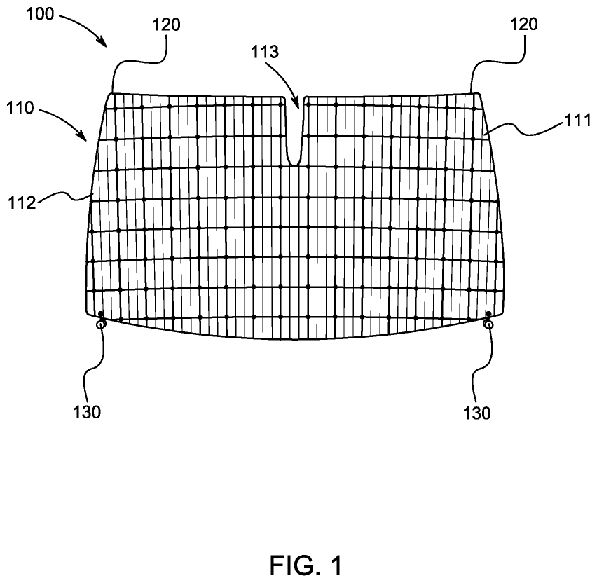

FIG. 1 illustrates an elevational front view of a retractable windshield shade 100, according to an exemplary embodiment of the present general inventive concept.

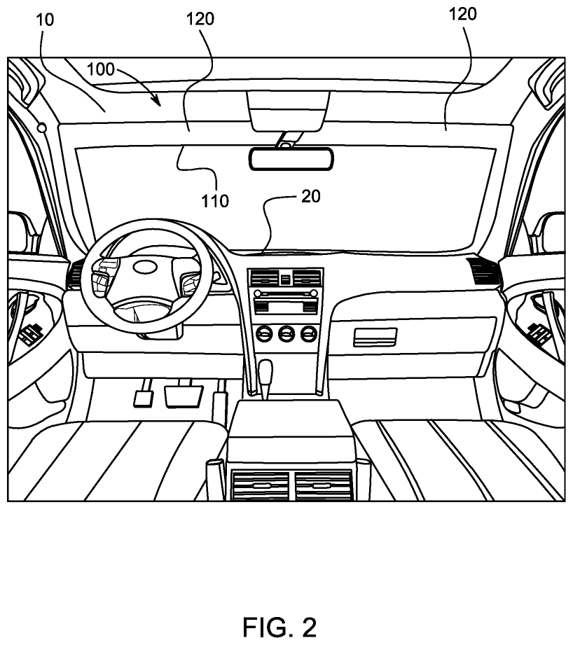

FIG. 2 illustrates a front perspective view of the retractable windshield shade 100 as disposed within an interior of a vehicle, according to an exemplary embodiment of the present general inventive concept.

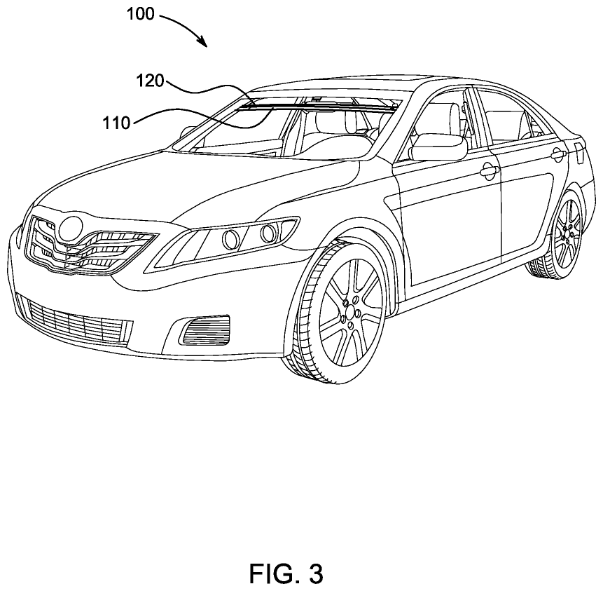

FIG. 3 illustrates a rear perspective view of the retractable windshield shade 100 as disposed within the interior of the vehicle, according to an exemplary embodiment of the present general inventive concept.

The retractable windshield shade 100 may be constructed from at least one of cloth, vinyl, textile, metal, plastic, wood, and rubber, etc., but is not limited thereto.

The retractable windshield shade 100 may include a main body 110, a roller connector 120, and a surface connector 130, but is not limited thereto.

The main body 110 may be constructed to fit a windshield of a particular make and/or brand of a vehicle. In other words, the main body 110 may have different sizes (e.g., length, width) and/or shapes based on a size (e.g., length, width) and/or a shape of the windshield corresponding to the make and/or the brand of the vehicle. Alternatively, the main body 110 may be a one-size fits all.

The main body 110 may include an interior side 111, an exterior side 112, and a mirror receiving channel 113, but is not limited thereto.

Referring to FIGS. 1 and 2, the interior side 111 may be oriented toward an interior of the vehicle while the main body 110 is disposed on the windshield. The interior side 111 may have a blackout feature. More specifically, the interior side 111 may be constructed to prevent movement of light therethrough, such as ultraviolet (UV) light. Moreover, the interior side 111 may decrease a light level within an interior of the vehicle. As such, the interior side 111 may darken the interior of the vehicle while the interior side 111 is extracted.

Referring to FIGS. 1 and 3, the exterior side 112 may be disposed on at least a portion of the interior side 111 (i.e., an opposite side of the main body 110). The exterior side 112 may be oriented toward the windshield while the main body 110 is disposed on the windshield. The exterior side 112 may be have a reflective surface. More specifically, the exterior side 112 may be constructed to reflect light away therefrom. Moreover, the exterior side 112 may reduce an amount of light reaching the interior of the vehicle through the windshield by reflecting the light away therefrom while the exterior side 112 is extracted.

Alternatively, the exterior side 112 may be constructed of coal, flat black, and/or carbon nanotube arrays to absorb the light. Therefore, the exterior side 112 may reduce the amount of light reaching the interior of the vehicle by preventing emission of the light after contacting the exterior side 112 while the exterior side 112 is extracted.

The mirror receiving channel 113 may be disposed on at least a portion of the interior side 111 and/or the exterior side 112. The mirror receiving channel 113 may receive a rear view mirror therebetween. As such, the mirror receiving channel 113 may facilitate placement of the main body 110 against the windshield.

Referring to FIGS. 2 and 3, the roller connector 120 is illustrated to be disposed within a headliner 10 of the vehicle. As such, retracting the main body 110 within the roller connector 120 may obscure (i.e., hide) the main body 110 within the headliner 10. However, the roller connector 120 may be disposed (i.e., installed) within a dashboard 20 of the vehicle. Also, the roller connector 120 may be removably connected (i.e., retrofit) and/or already installed during manufacture of the vehicle.

The roller connector 120 may be connected to at least a portion of the main body 110. Additionally, the roller connector 120 may receive and/or store the main body 110 therein. In particular, the roller connector 120 may coil the main body 110 therein. As such, the main body 110 may be movably (i.e., rotatably) disposed within the roller connector 120. Therefore, the main body 110 may move (i.e., rotate) from retracted within the roller connector 120 in a first position to at least partially extracted away from the roller connector 120 in a second position. Conversely, the main body 110 may move from extracted away from the roller connector 120 in the second position to retracted within the roller connector 120 in the first position.

Also, the main body 110 may be moved (i.e., tugged) via a first application of force (e.g., pushing, pulling) away from the roller connector 120, such that the main body 110 may retract via a spring within the roller connector 120. The main body 110 may move in response to a second application of force (e.g., pushing, pulling) to extract the main body 110 from the roller connector 120. The main body 110 may be set to hold a position in absence of the application of force. For example, the main body 110 may be moved to cover half the windshield of the vehicle and left at that position. Subsequently, the main body 110 may be tugged to cause the main body 110 to retract within the roller connector 120.

The surface connector 130 may include a hook, a clip, a clamp, a clasp, an adhesive (e.g., tape, glue), a magnet, and/or any combination thereof, but is not limited thereto.

The surface connector 130 may be disposed on at least a portion of the main body 110. The surface connector 130 may connect the main body 110 to the dashboard 20 and/or the headliner 10 depending on whether the roller connector 120 is disposed within the headliner 10 and/or the dashboard 20, respectively. In other words, the surface connector 130 may connect to an opposite surface of the vehicle from where the roller connector 120 is disposed.

Therefore, the retractable windshield shade 100 may protect the interior of the vehicle from Sun damage and/or damage from UV light that cracks and/or overheats the interior of the vehicle. Also, the retractable windshield shade 100 may save time for a user by eliminating the need to obtain a separate accessory and maintain comfortable temperatures within the interior of the vehicle.

The present general inventive concept may include a retractable windshield shade 100 removably connected to at least a portion of a vehicle, the retractable windshield shade 100 including a main body 110 to movably cover a windshield of the vehicle, a roller connector 120 disposed on at least a portion of the main body 110 and connected within a headliner 10 of the vehicle to store the main body 110 therein, such that the main body 110 moves from retracted within the roller connector 120 in a first position to at least partially extracted away from the roller connector 120 in a second position, and moves from extracted away from the roller connector 120 in the second position to retracted within the roller connector 120 in the first position, and a surface connector 130 disposed on at least a portion of the main body 110 to removably connect the main body 110 to a dashboard 20 of the vehicle.

The main body 110 may include an interior side 111 to darken an interior of the vehicle while the interior side is extracted, and an exterior side 112 disposed on at least a portion of the interior side 111 to reduce an amount of light reaching the interior of the vehicle through the windshield.

The exterior side 112 may be a reflective surface that reflects the light away therefrom.

The exterior side 112 may absorb the light and prevents emission of the light away therefrom.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A retractable windshield shade removably connected to at least a portion of a vehicle, the retractable windshield shade comprising:
a main body to movably cover a windshield of the vehicle;
a roller connector disposed on at least a portion of the main body and connected within a headliner of the vehicle to store the main body therein, such that the main body moves from retracted within the roller connector in a first position to at least partially extracted away from the roller connector in a second position, and moves from extracted away from the roller connector in the second position to retracted within the roller connector in the first position; and
a surface connector disposed on at least a portion of the main body to removably connect the main body to a dashboard of the vehicle.

2. The retractable windshield shade of claim 1, wherein the main body comprises:
an interior side to darken an interior of the vehicle while the interior side is extracted; and
an exterior side disposed on at least a portion of the interior side to reduce an amount of light reaching the interior of the vehicle through the windshield.

3. The retractable windshield shade of claim 2, wherein the exterior side is a reflective surface that reflects the light away therefrom.

4. The retractable windshield shade of claim 2, wherein the exterior side absorbs the light and prevents emission of the light away therefrom.
